(19) United States
(12) Patent Application Publication
(10) Pub. No.: US 2018/0139467 A1
(43) Pub. Date: May 17, 2018

(54) MEDICAL IMAGING APPARATUS, MEDICAL IMAGE PROCESSING METHOD, AND COMPUTER-READABLE RECORDING MEDIUM RELATED TO THE MEDICAL IMAGE PROCESSING METHOD

(71) Applicant: Samsung Electronics Co., Ltd., Suwon-si (KR)

(72) Inventors: Duhgoon Lee, Yongin-si (KR); Kyoung-yong Lee, Hwaseong-si (KR); Baeg-gi Min, Anyang-si (KR); Ji-young Choi, Suwon-si (KR)

(21) Appl. No.: 15/812,744

(22) Filed: Nov. 14, 2017

(30) Foreign Application Priority Data
Nov. 14, 2016 (KR) 10-2016-0151304

(51) Int. Cl. H04N 19/52; G06T 7/20; G06T 11/00; G06T 7/00

(52) U.S. Cl. CPC H04N 19/52; G06T 7/20; G06T 11/003; G06T 2207/10132; G06T 2207/10081; G06T 2207/20104; G06T 2207/10088; G06T 7/97

(57) ABSTRACT

A medical imaging apparatus and a medical image processing method are provided. The medical imaging apparatus includes a data obtainer configured to obtain raw data by performing a tomography scan on an object. The medical imaging apparatus also includes a processor configured to obtain first data and second data from raw data and extract motion information based on the first data and the second data. An output interface is configured to provide the extracted motion information.

### CROSS-REFERENCE TO RELATED APPLICATION

This application is related to and claims priority to Korean Patent Application No. 10-2016-0151304, filed on Nov. 14, 2016, the disclosure of which is incorporated herein in its entirety by reference.

### TECHNICAL FIELD

The present disclosure relates to a medical imaging apparatus, a medical image processing method, and a computer-readable recording medium having recorded thereon computer program code for executing the medical image processing method.

### BACKGROUND

Medical imaging apparatuses are equipment for capturing images of an internal structure of an object. Medical imaging apparatuses are noninvasive examination apparatuses that capture and process images of the structural details of an object, internal tissue thereof, and fluid flow within the object and provide the processed images to a user. A user, such as a doctor, may diagnose a health state and a disease of a patient by using a medical image output from a medical imaging apparatus. A process of scanning an object and obtaining raw data is required to obtain a medical image. However, when a moving object is scanned, motion artifacts occur, and thus the quality of a medical image degrades.

### SUMMARY

To address the above-discussed deficiencies, it is a primary object to provide extracting motion information of an object, based on raw data obtained by scanning the object, and providing a user with the extracted motion information of the object.

Provided are a medical imaging apparatus and a medical image processing method enabling a user to easily check occurrence or non-occurrence of motion artifacts and the degree of the motion artifacts by displaying motion information according to various methods.

Additional aspects will be set forth in part in the description which follows and, in part, will be apparent from the description, or may be learned by practice of the presented embodiments.

According to an aspect of an embodiment, a medical imaging apparatus includes a data obtainer configured to obtain raw data by performing a tomography scan on an object; a processor configured to obtain first data and second data from raw data and extract motion information, based on the first data and the second data; and an output interface configured to provide the extracted motion information.

The output interface may display the motion information as at least one of a value of a motion index and a motion map.

The output interface may display the motion information with a medical image generated by reconstructing the raw data.

The output interface may provide varying motion information in real time as the tomography scan on the object proceeds.

The processor may calculate a motion vector, based on the first data and the second data, and extract the motion information, based on the motion vector.

The processor may extract at least one pixel of which a size of a motion vector is equal to or greater than a threshold, from a plurality of pixels corresponding to a field of interest (FOI), and calculate a value of a motion index by using the size of the motion vector of the extracted at least one pixel. The output interface may output the calculated value of the motion index as the motion information.

The processor may generate a motion map by mapping a certain color to each of the pixels according to the size of the motion vector of each of the pixels.

The output interface may overlap a medical image generated by reconstructing the raw data with the motion map and displays a result of the overlapping.

The processor may reconstruct a first image and a second image, based on the first data and the second data, and calculate a motion vector of each pixel by using the first image and the second image.

The output interface may output a notification message when a value of a motion index provided as the motion information is equal to or greater than a threshold.

The processor may stop scanning when it is determined that a motion amount of the object is equal to or greater than a threshold, based on the motion information, and re-scan the object from a location on the object where the scanning has stopped.

The first data and the second data may respectively correspond to different angular sections.

The different angular sections may be opposite angular sections and in a range of 0° or greater to less than 180°.

According to an aspect of an embodiment, a medical image processing method includes obtaining raw data by performing a tomography scan on an object; obtaining first data and second data from the raw data; extracting motion information, based on the first data and the second data; and providing the extracted motion information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a computed tomography (CT) system according to an embodiment;

FIG. 2 illustrates a medical imaging apparatus according to an embodiment;

FIG. 3 illustrates a method of calculating a motion vector, according to an embodiment;

FIG. 4 illustrates a method of calculating a motion index, according to an embodiment;

FIGS. 5A and 5B illustrate a method of displaying a motion index in various ways, according to an embodiment;

FIG. 6 illustrates a method of calculating a motion map, according to an embodiment;

FIG. 7 illustrates a method of displaying a motion map in various ways, according to an embodiment;

FIGS. 8A and 8B illustrate a method of displaying a motion index in real time according to an embodiment; and

FIG. 9 illustrates a medical image processing method according to an exemplary embodiment.

### DETAILED DESCRIPTION

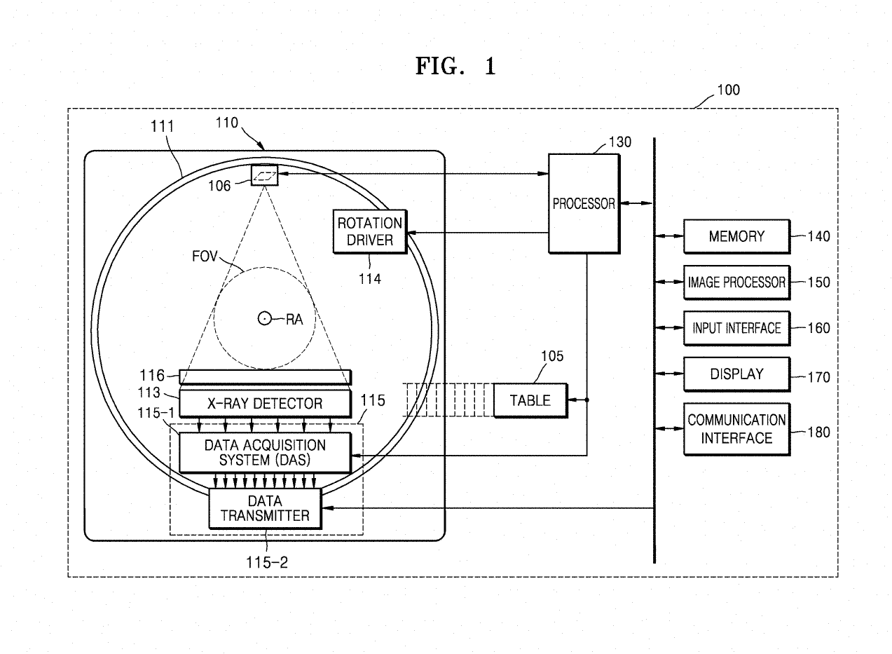

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The principle of the present disclosure is explained and embodiments are disclosed so that the scope of the present disclosure is clarified and one of ordinary skill in the art to which the present disclosure pertains implements the present disclosure. The disclosed embodiments may have various forms.

Throughout the specification, like reference numerals or characters refer to like elements. In the present specification, all elements of embodiments are not explained, but general matters in the technical field of the present disclosure or redundant matters between embodiments will not be described. Terms ‘part’ and ‘portion’ used herein may be implemented using software or hardware, and, according to embodiments, a plurality of ‘parts’ or ‘portions’ may be implemented using a single unit or element, or a single ‘part’ or ‘portion’ may be implemented using a plurality of units or elements. The operational principle of the present disclosure and embodiments thereof will now be described more fully with reference to the accompanying drawings.

In the present specification, an image may include a medical image obtained by a medical imaging apparatus, such as a computed tomography (CT) apparatus, a magnetic resonance imaging (MRI) apparatus, an ultrasound imaging apparatus, or an X-ray apparatus.

Throughout the specification, the term ‘object’ is a thing to be imaged, and may include a human, an animal, or a part of a human or animal. For example, the object may include a part of a body (i.e., an organ), a phantom, or the like.

In the present specification, a ‘CT system’ or ‘CT apparatus’ refers to a system or apparatus configured to emit X-rays while rotating around at least one axis relative to an object and photograph the object by detecting the X-rays.

In the specification, a ‘CT image’ refers to an image constructed from raw data obtained by photographing an object by detecting X-rays that are emitted as the CT system or apparatus rotates about at least one axis with respect to the object.

FIG. 1 illustrates a structure of a CT system 100 according to an embodiment.

The CT system 100 may include a gantry 110, a table 105, a processor 130, a memory 140, an image processor 150, an input interface 160, a display 170, and a communication interface 180.

The gantry 110 may include a rotating frame 111, an X-ray generator 112, an X-ray detector 113, a rotation driver 114, and a readout device 115.

The rotating frame 111 may receive a driving signal from the rotation driver 114 and rotate around a rotation axis (RA).

An anti-scatter grid 116 may be disposed between an object and the X-ray detector 113 and may transmit most of primary radiation and attenuate scattered radiation. The object may be positioned on the table 105 which may move, tilt, or rotate during a CT scan.

The X-ray generator 112 receives a voltage and a current from a high voltage generator (HVG) to generate and emit X-rays.

The CT system 100 may be implemented as a single-source CT system including one X-ray generator 112 and one X-ray detector 113, or as a dual-source CT system including two X-ray generators 112 and two X-ray detectors 113.

The X-ray detector 113 detects radiation that has passed through the object. For example, the X-ray detector 113 may detect radiation by using a scintillator, a photon counting detector, etc.

Methods of driving the X-ray generator 112 and the X-ray detector 113 may vary depending on scan modes used for scanning of the object. The scan modes are classified into an axial scan mode and a helical scan mode, according to a path along which the X-ray detector 113 moves. Furthermore, the scan modes are classified into a prospective mode and a retrospective mode, according to a time interval during which X-rays are emitted.

The processor 130 may control an operation of each of the components of the CT system 100. The processor 130 may include a memory configured to store program codes for performing a function or data and a processor configured to process the program codes or the data. The processor 130 may be implemented in various combinations of at least one memory and at least one processor. The processor may generate or delete a program module according to an operating status of the CT system 100 and process operations of the program module.

The readout device 115 receives a detection signal generated by the X-ray detector 113 and outputs the detection signal to the image processor 150. The readout device 115 may include a data acquisition system (DAS) 115-1 and a data transmitter 115-2. The DAS 115-1 uses at least one amplifying circuit to amplify a signal output from the X-ray detector 113, and outputs the amplified signal. The data transmitter 115-2 uses a circuit such as a multiplexer (MUX) to output the signal amplified in the DAS 115-1 to the image processor 150. According to a slice thickness or a number of slices, only some of a plurality of pieces of data collected by the X-ray detector 113 may be provided to the image processor 150, or the image processor 150 may select only some of the plurality of pieces of data.

The image processor 150 obtains tomography data from a signal obtained by the readout device 115 (e.g., pure data that is data before being processed). The image processor 150 may pre-process the obtained signal, convert the obtained signal into tomography data, and post-process the tomography data. The image processor 150 may perform some or all of the processes described herein, and the type or order of processes performed by the image processor 150 may vary according to embodiments.

The image processor 150 may perform pre-processing, such as a process of correcting sensitivity irregularity between channels, a process of correcting a rapid decrease of signal strength, or a process of correcting signal loss due to an X-ray absorbing material, on the signal obtained by the readout device 115.

According to embodiments, the image processor 150 may perform some or all of the processes for reconstructing a tomography image, to thereby generate the tomography data. According to an embodiment, the tomography data may be in the form of data that has undergone back-projection, or in the form of a tomography image. According to embodiments, additional processing may be performed on the tomography data by an external device such as a server, a medical apparatus, or a portable device.

Raw data is a set of data values corresponding to intensities of X-rays that have passed through the object, and may include projection data or a sinogram. The data that has undergone back-projection is obtained by performing back-projection on the raw data by using information about an angle at which X-rays are emitted. The tomography image is obtained by using image reconstruction techniques including back-projection of the raw data.

The memory 140 is a storage medium for storing control-related data, image data, etc., and may include a volatile or non-volatile storage medium.

The input interface 160 receives control signals, data, etc., from a user. The display 170 may display information indicating an operational status of the CT system 100, medical information, medical image data, etc.

The CT system 100 includes the communication interface 180 and may be connected to external devices, such as a server, a medical apparatus, and a portable device (smartphone, tablet personal computer (PC), wearable device, etc.), via the communication interface 180.

The communication interface 180 may include one or more components that enable communication with an external device. For example, the communication interface 180 may include a short distance communication module, a wired communication module, and a wireless communication module.

The communication interface 180 may receive control signals and data from an external device and transmit the received control signals to the processor 130 so that the processor 130 may control the CT system 100 according to the received control signals.

Alternatively, by transmitting a control signal to an external device via the communication interface 180, the processor 130 may control the external device according to the control signal.

For example, the external device may process data according to a control signal received from the processor 130 via the communication interface 180.

A program for controlling the CT system 100 may be installed on the external device and may include instructions for performing some or all of the operations of the processor 130.

The program may be preinstalled on the external device, or a user of the external device may download the program from a server that provides an application for installation. The server that provides an application may include a recording medium having the program recorded thereon.

According to embodiments, the CT system 100 may or may not use contrast media during a CT scan, and may be implemented as a device connected to other equipment.

To obtain a tomography image, the CT system 100 performs a tomography scan on the object and thus obtains raw data. The CT system 100 generates X-rays, radiates the X-rays onto the object, and detects X-rays transmitted by the object by using the X-ray detector 113. The X-ray detector 113 generates raw data corresponding to the detected X-rays. The raw data may mean data that has not yet been reconstructed to the tomography image by the image processor 150.

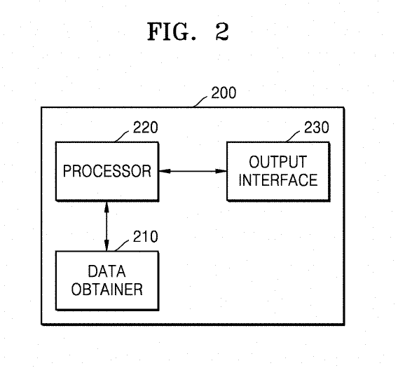

FIG. 2 illustrates a medical imaging apparatus 200 according to an embodiment.

The medical imaging apparatus 200 processes and displays medical image data and may be implemented as an electronic device. For example, the medical imaging apparatus 200 may be implemented as any one of various types of devices including a processor and a display, such as a general-purpose computer, a tablet personal computer (PC), and a smartphone.

Referring to FIG. 2, the medical imaging apparatus 200 may include a data obtainer 210, an image processor 220, and an output interface 230. However, the medical imaging apparatus 200 may be implemented by more or less components than the components illustrated in FIG. 2.

The aforementioned components will now be described in detail.

The data obtainer 210 may obtain raw data by performing a tomography scan on an object. The raw data may be obtained according to various methods. For example, the raw data may be obtained from a scanner of the medical imaging apparatus 200 or received from an external apparatus.

According to an embodiment, the data obtainer 210 corresponds to a scanner of a medical imaging apparatus, and may include the gantry 110 of the CT system 100 of FIG. 1. Accordingly, the data obtainer 210 may include the rotating frame 111, the X-ray generator 112, the X-ray detector 113, the rotation driver 114, and the readout device 115 of FIG. 1.

According to another embodiment, the data obtainer 210 may be implemented as a communicator that communicates with an external apparatus. The data obtainer 210 may receive the raw data obtained by scanning the object, from the external apparatus.

The processor 220 performs predetermined processing, based on a received user input. The processor 220 may be implemented in various combinations of at least one memory and at least one processor. For example, the memory may generate or delete a program module according to an operation of the processor 220, and the processor 220 may process operations of the program module.

According to an embodiment, the processor 220 obtains first data and second data from the raw data obtained by the data obtainer 210. For example, the first data and the second data may be raw data respectively corresponding to different angular sections. The different angular sections may be in the range of 0° or greater to less than 180° and may include, but are not limited to, opposite angular sections.

According to an embodiment, the processor 220 extracts motion information, based on the first data and the second data.

According to an embodiment, the processor 220 may calculate a motion vector, based on the first data and the second data. For example, the processor 220 may reconstruct a first image and a second image, based on the first data and the second data, and calculate a motion vector of each pixel by using the first image and the second image. For example, when the first data and the second data are raw data respectively corresponding to angular sections of between 0° and 180° as different angular sections, the reconstructed first image and the reconstructed second image may be partial angle reconstruction images. For example, the partial angle reconstruction images are images reconstructed according to a partial angle reconstruction method, and may not represent the entire object but represent a portion of the object. For example, the partial angle reconstruction images represent surface information of the object with respect to some directions.

According to an embodiment, the processor 220 may extract the motion information, based on the calculated motion vector. For example, the motion information may be expressed as a value of a motion index, a motion map, a motion vector field (MVF), or the like. The motion index may mean a representative value representing the degree of motion artifacts occurring in a medical image. The motion map may mean a result of mapping a certain color to each pixel according to the size of a motion vector of each pixel. The MVF is information representing a motion vector of each pixel or voxel, and may include two-dimensional (2D) or three-dimensional (3D) vectors.

According to an embodiment, the processor 220 may calculate a value of a motion index, based on the motion vector. For example, the processor 220 may extract at least one pixel of which a motion vector is equal to or greater than a threshold, from a plurality of pixels corresponding to a field of interest (FOI). The processor 220 may calculate a value of a motion index by using the size of the motion vector of the extracted at least one pixel. For example, the processor 220 may calculate a mean value of the size of the motion vector of the extracted at least one pixel and may map the calculated mean value to a predetermined value of a motion index.

According to an embodiment, the processor 220 may change a value of a motion index mapped with the size of a specific motion vector according to settings. For example, when the size of the motion vector is 4 mm, a value of a motion index mapped with the size of the motion vector may be changed from 2 to 3 according to settings.

According to an embodiment, the processor 220 may provide a value of a motion index for one scan as motion information and thus may express a motion amount of the object generated during the scan as a representative value. According to another embodiment, the processor 220 may calculate a value of a motion index for each slice image that represents a specific cross-section of the object.

According to an embodiment, the processor 220 may generate a motion map, based on the motion vector. For example, the processor 220 may generate the motion map by mapping a certain color to each pixel according to the size of the motion vector of each pixel.

According to an embodiment, the processor 220 may automatically stop scanning when it is determined based on the motion information that the motion amount of the object is equal to or greater than a threshold. The processor 220 may re-scan the object from a location on the object where the scanning has stopped. According to an embodiment, the processor 220 may re-scan the object from the beginning.

The output interface 230 may display a medical image obtained by performing a tomography scan on the object.

When the output interface 230 is implemented as a touch screen, the output interface 230 may be used as an input device as well as an output device. The output interface 230 may be implemented as, for example, a liquid crystal display (LCD), a thin film transistor-liquid crystal display (TFT-LCD), an organic light-emitting diode (OLED) display, a flexible display, a 3D display, or an electrophoretic display. According to embodiments of the medical imaging apparatus 200, the medical imaging apparatus 200 may include at least two output interfaces 230.

According to an embodiment, the output interface 230 may provide the motion information. For example, the output interface 230 may display the motion information as at least one of a motion index and a motion map. For example, the output interface 230 may display at least one of a motion index and a motion map together with the medical image obtained by scanning the object. For example, when the motion information is provided as a motion map, the output interface 230 may display the motion map independently from the medical image. According to an embodiment, the output interface 230 may overlap the medical image with the motion map or compose the medical image and the motion map such that the motion information is displayed on the medical image.

According to an embodiment, the output interface 230 may output a message indicating that the motion amount of the object is equal to or greater than the threshold based on the motion information. For example, when the value of the motion index is equal to or greater than a threshold, the output interface 230 may output a message indicating that a re-scan is necessary. According to another embodiment, when the value of the motion index is equal to or greater than the threshold, the output interface 230 may output a certain sound or distinguish and display the value of the motion index in a specific color. Accordingly, by providing the motion information using various methods, the medical imaging apparatus 200 enables a user to more quickly check occurrence or non-occurrence of motion artifacts in a medical image and the degree of the motion artifacts. In addition, by displaying information indicating that a motion amount of the object generated during a scan is equal to or greater than a threshold, the medical imaging apparatus 200 enables a user to more rapidly determine whether a re-scan is necessary.

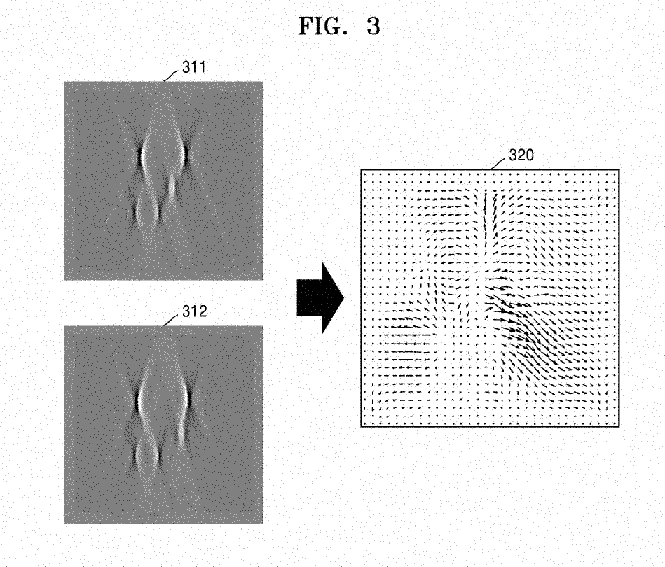

FIG. 3 illustrates a method of calculating a motion vector, according to an embodiment.

According to an embodiment, the medical imaging apparatus 200 may obtain raw data by performing a tomography scan on an object and obtain first data and second data from the raw data.

According to an embodiment, the medical imaging apparatus 200 may reconstruct a first image 311 and a second image 312 by using the first data and the second data. For example, when the first data and the second data are raw data respectively corresponding to opposite angular sections as angular sections of 0° or greater to less than 180°, the reconstructed first image 311 and the reconstructed second image 312 may be partial angle reconstruction images. However, according to an embodiment, when the first data and the second data are raw data respectively corresponding to different angular sections of 180° or greater, the reconstructed first image 311 and the reconstructed second image 312 may be complete images.

According to an embodiment, the medical imaging apparatus 200 may calculate a motion vector 320 of each pixel by using the first image 311 and the second image 312. For example, referring to FIG. 3, the medical imaging apparatus 200 may calculate the motion vector 320 of each pixel by comparing the first image 311 with the second image 312.

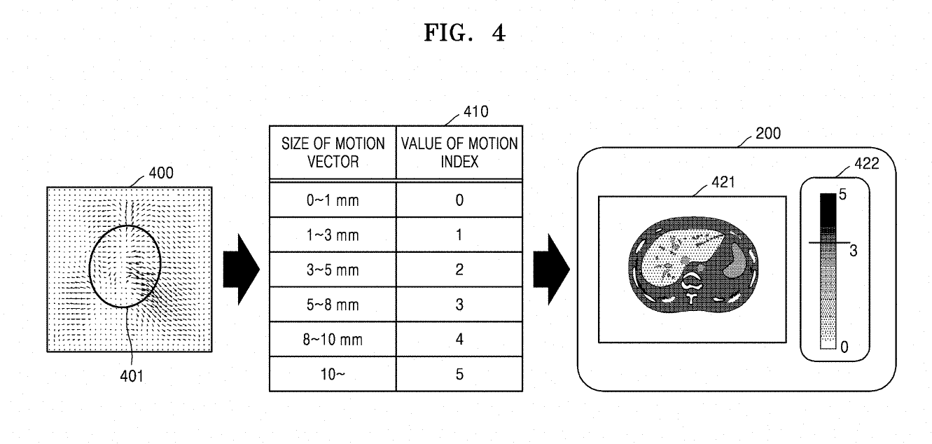

FIG. 4 illustrates a method of calculating a motion index, according to an embodiment.

A medical image obtained by scanning an object may include even a field other than an FOI of a user. For example, a medical image obtained by scanning the chest of a patient to observe the lungs of the patient may include not only the lungs of the patient but also the heart thereof. Because the heart moves all the time, motion artifacts due to movements of the heart may occur in the medical image obtained by scanning the chest of the patient. However, because the FOI of the user is a region corresponding to the lungs, occurrence or non-occurrence of motion artifacts in the region corresponding to the lungs may be important to accurately observe the lungs from the medical image. The user may check motion information of the FOI to determine whether a motion amount detected from the FOI is equal to or greater than a threshold. When the motion amount detected from the FOI is equal to or greater than the threshold, the user may determine that a re-scan is necessary, in order to achieve accurate reading.

According to an embodiment, the medical imaging apparatus 200 may determine values of motion index's according to sizes of motion vectors of a plurality of pixels corresponding to the FOI. For example, referring to FIG. 4, the medical imaging apparatus 200 may extract at least one pixel of which a motion vector is equal to or greater than a threshold, from a plurality of pixels 401 corresponding to the FOI 400. The medical imaging apparatus 200 may calculate a value of a motion index by using the size of the motion vector of the extracted at least one pixel. For example, the medical imaging apparatus 200 may calculate a value that represents the size of the motion vector of the extracted at least one pixel. For example, the value that represents the size of the motion vector of the extracted at least one pixel may mean a mean value of the size of the motion vector, but embodiments are not limited thereto.

According to an embodiment, the medical imaging apparatus 200 may map the value that represents the size of the motion vector to a predetermined value of a motion index. For example, the medical imaging apparatus 200 may map the value that represents the size of the motion vector to the predetermined value of the motion index, by using a mapping table 410 of FIG. 4. For example, when the value that represents the size of the motion vector is 6.5 mm, the medical imaging apparatus 200 may set the value of the motion index to be 3.

The medical imaging apparatus 200 may change a value of a motion index mapped with the size of a specific motion vector according to settings. For example, referring to the mapping table 410 of FIG. 4, the value of the motion index may be set to have a range of 0 to 5, but may vary according to external inputs or internal instructions of the medical imaging apparatus 200.

According to an embodiment, the medical imaging apparatus 200 may display the calculated value of the motion index as motion information. The medical imaging apparatus 200 may display the calculated value of the motion index together with the medical image. For example, referring to FIG. 4, the medical imaging apparatus 200 may display the calculated value of the motion index as a graphical user interface (GUI) 422 representing which location in the entire motion index range the calculated value of the motion index corresponds to, together with a medical image 421. The medical imaging apparatus 200 provides the calculated value of the motion index as the motion information to enable a user to easily check the motion information of the FOI.

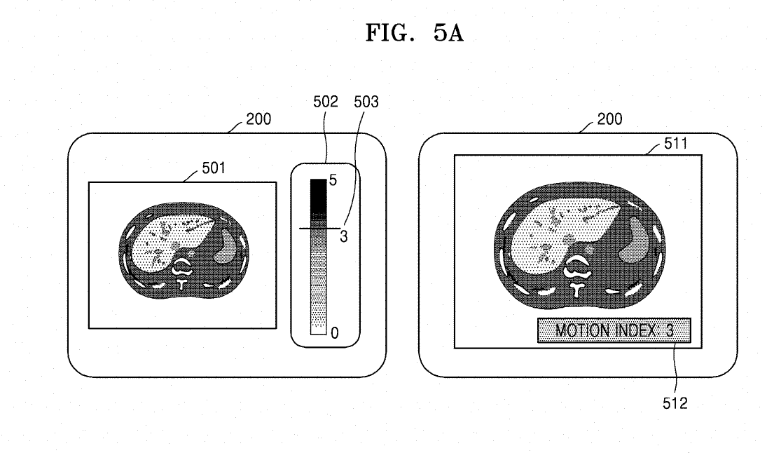

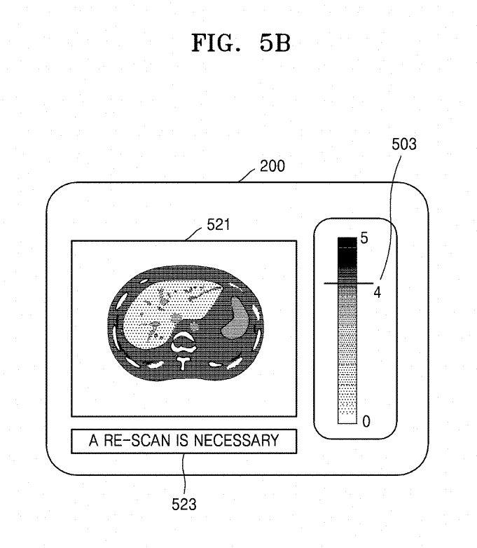

FIGS. 5A and 5B illustrate a method of displaying a motion index in various ways, according to an embodiment.

According to an embodiment, the medical imaging apparatus 200 may display a value of a motion index as motion information. For example, the medical imaging apparatus 200 may display the value of the motion index together with a medical image obtained by scanning an object. According to another embodiment, the medical imaging apparatus 200 may display the value of the motion index independently from the medical image. For example, referring to FIG. 5A, the medical imaging apparatus 200 may display a calculated value of the motion index as a bar graph GUI 502 representing which location in the entire motion index range the calculated index value corresponds to, together with a medical image 501. For example, the medical imaging apparatus 200 may display a range of a value of a motion index (for example, 0 to 5) and mark a relative location of a value of a motion index 503 corresponding to the medical image 501, by using the bar graph GUI 502. Accordingly, the medical imaging apparatus 200 enables a user to easily check motion information corresponding to the medical image 501. For example, when the value of the motion index 503 corresponding to the medical image 501 is 3, as shown in FIG. 5A, the user may easily check a relative size of the value of the motion index 503, based on a location or color corresponding to the number 3 on the bar graph GUI 502 indicating values of 0 to 3.

According to another embodiment, the medical imaging apparatus 200 may express a value of a motion index as a number. For example, as shown in FIG. 5B, the medical imaging apparatus 200 may display the value of the motion index within a medical image 511, via an indicator 512 indicating a number corresponding to the value of the motion index. The medical imaging apparatus 200 may display the indicator 512 indicating a value of a motion index in different colors according to different values of motion indexes. For example, when a value of a motion index is equal to or greater than a threshold, the medical imaging apparatus 200 may highlight the indicator 512 indicating the value of the motion index or display a number representing the value of the motion index in a specific color (for example, red), thereby indicating that motion artifacts occurring in the FOI are equal to or greater than a threshold level.

According to an embodiment, the medical imaging apparatus 200 may additionally display whether a re-scan is necessary, while displaying a motion index. For example, when a value of a motion index is equal to or greater than a threshold, the medical imaging apparatus 200 may output a message indicating that a re-scan is necessary. For example, referring to FIG. 5B, the medical imaging apparatus 200 may display a message indicating that a re-scan is necessary, via a separate window 523. As another example, the medical imaging apparatus 200 may display the message indicating that a re-scan is necessary, as a pop-up window. Accordingly, a user may easily check whether motion artifacts occur in a reconstructed medical image and the degree of the motion artifacts, without needing to directly check the reconstructed medical image, and may quickly determine whether a re-scan is necessary.

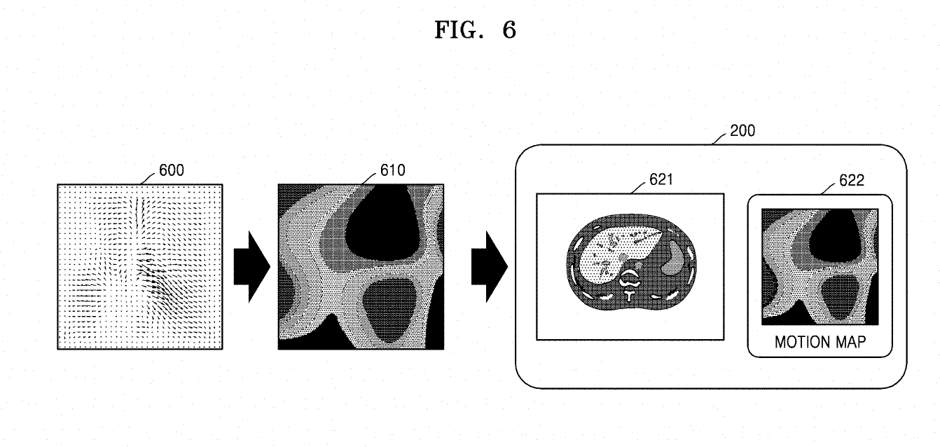

FIG. 6 illustrate a method of calculating a motion map, according to an embodiment.

The motion map may mean a result of mapping a certain color to each pixel according to the size of a motion vector of each pixel. For example, the motion map may be in the form of a 2D image having a resolution that is less than or equal to the resolution of a medical image generated by reconstructing raw data. For example, referring to FIG. 6, the medical imaging apparatus 200 may map a predetermined color to each pixel according to the size of a motion vector of each pixel, based on a result 600 of calculating the motion vector of each pixel, to thereby generate a motion map 610. For example, when the resolution of the medical image generated by reconstructing the raw data is 512×512, the motion map 610 may be in the form of a 2D image having a 512×512 resolution.

The medical imaging apparatus 200 according to an embodiment maps a predetermined color according to the size of the motion vector of each pixel, according to a preset criterion. For example, the medical imaging apparatus 200 may map a blue color when the size of the motion vector is 0 mm or greater to less than 1 mm, a sky-blue color when the size of the motion vector is 1 mm or greater to less than 3 mm, and a green color when the size of the motion vector is 3 mm or greater to less than 5 mm. The medical imaging apparatus 200 may map a yellow color when the size of the motion vector is 5 mm or greater to less than 8 mm, an orange color when the size of the motion vector is 8 mm or greater to less than 10 mm, and a red color when the size of the motion vector is 10 mm or greater. However, colors mapped according to sizes of motion vectors may vary according to embodiments, and embodiments are not limited thereto.

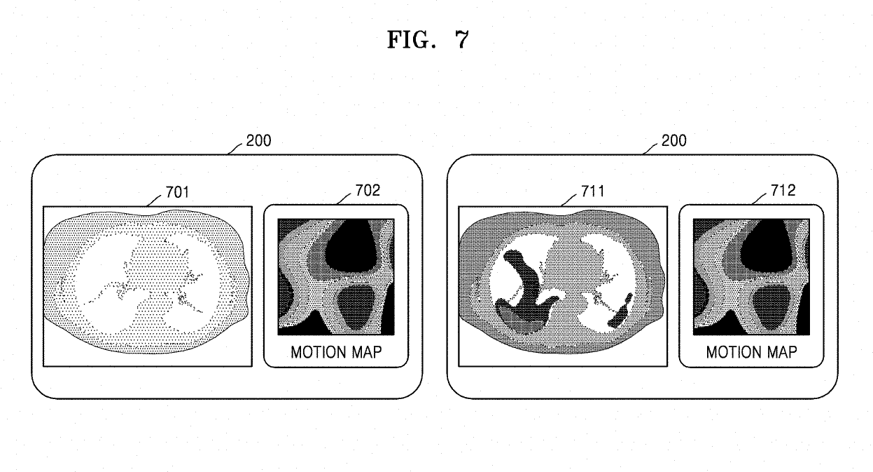

The medical imaging apparatus 200 according to an embodiment may provide the motion map 610 as motion information. For example, referring to FIG. 6, the medical imaging apparatus 200 may display a medical image 621 obtained by reconstructing raw data, and a motion map 622 together. A method of displaying a motion map will now be described with reference to FIG. 7.

FIG. 7 illustrate a method of displaying a motion map in various ways, according to an embodiment.

According to an embodiment, the medical imaging apparatus 200 may display a motion map 702 together with a medical image 701 obtained by scanning an object. A user may recognize a region having a relatively large motion vector by using the motion map 702. The region having a relatively large motion vector may mean a region having a large motion amount of the object. By comparing the medical image 701 with the motion map 702, the user may check whether motion artifacts have occurred in an FOI within the medical image 701, and the degree of the motion artifacts.

According to an embodiment, the medical imaging apparatus 200 may overlap a medical image obtained by scanning an object with a motion map and display a result 711 of the overlapping. According to another embodiment, the medical imaging apparatus 200 may compose a medical image and a motion map 712 to generate a single image, and display the single image. Accordingly, the medical imaging apparatus 200 enables motion information to be expressed on the medical image. A user may check the motion information from the medical image and thus easily check whether motion artifacts have occurred in each region within the medical image, and the degree of the motion artifacts.

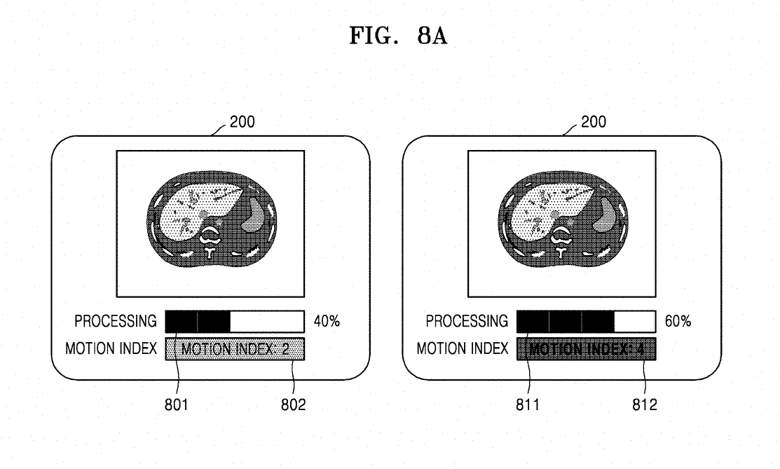

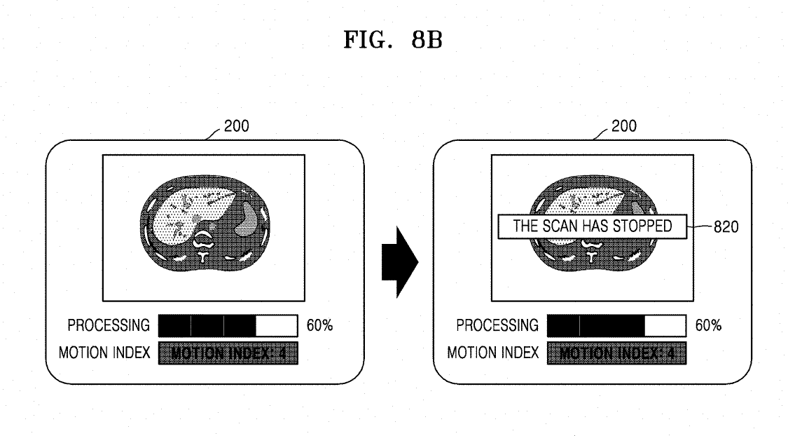

FIG. 8A illustrate a method of displaying a value of a motion index in real time, according to an embodiment.

According to an embodiment, the medical imaging apparatus 200 may provide motion information that varies as a scan proceeds, in real time. For example, the medical imaging apparatus 200 may display the value of the motion index that varies as a scan proceeds, together with a proceeding status of the scan. Referring to FIG. 8A, the medical imaging apparatus 200 may display a status bar 801 indicating that a scan of an object has proceeded 40%, together with a value of a motion index that varies in real time.

According to an embodiment, the medical imaging apparatus 200 may obtain first data and second data corresponding to an angular section of 0° or greater to less than 180° (for example, 50°), in real time. For example, the first data and the second data may be raw data respectively corresponding to opposite angular sections. For example, the two angular sections respectively corresponding to the first data and the second data may have a difference of 180° therebetween. The medical imaging apparatus 200 may obtain a first image and a second image in real time by reconstructing the first data with the second data obtained in real time. The reconstructed first image and the reconstructed second image may be partial angle reconstruction images.

According to an embodiment, the medical imaging apparatus 200 may calculate, in real time, a motion vector by using the first image and the second image obtained in real time. The medical imaging apparatus 200 may calculate a motion index in real time, based on the motion vector calculated in real time.

According to another embodiment, the medical imaging apparatus 200 may calculate a brightness difference for each pixel, by comparing the first data with the second data obtained in real time. The medical imaging apparatus 200 may calculate a motion index in real time, based on the brightness difference for each pixel. For example, the medical imaging apparatus 200 may map different values of motion indexes according to different values representing brightness differences. For example, the medical imaging apparatus 200 may determine values of motion indexes according to values representing brightness differences, by using a preset look-up table. For example, as a brightness difference between the first data and the second data increases, the value of the motion index may increase.

As the scan proceeds, the first data and the second data obtained in real time may vary, and accordingly, the first image and the second image may also vary. Accordingly, as the scan proceeds, the value of the motion index calculated in real time may also vary. For example, as shown in FIG. 8A, when 40% of the scan has proceeded, the value of the motion index may be 2, and, when 60% (status bar 811) of the scan has proceeded, the value of the motion index may be 4. In this case, the medical imaging apparatus 200 may display calculated values of motion indexes to be distinguished from each other. For example, when values of motion indexes are equal to or greater than the threshold, the medical imaging apparatus 200 may display indicators 802 and 812 representing the values of the motion index in specific colors such that the values of the motion indexes are distinguished from each other. Referring to FIG. 8A, the medical imaging apparatus 200 may display the indicator 812 representing a value of a motion index that is equal to or greater than 3, in a red color. Accordingly, the medical imaging apparatus 200 enables a user to easily determine whether a motion amount of an object is equal to or greater than a threshold.

According to an embodiment, the medical imaging apparatus 200 may automatically stop scanning when it is determined based on the motion information that the motion amount of the object is equal to or greater than the threshold. For example, the medical imaging apparatus 200 may automatically stop scanning when a value of a motion index that varies in real time is equal to or greater than 3. For example, as shown in FIG. 8B, when a value of a motion index when 60% of a scan has proceeded is 4, the medical imaging apparatus 200 may stop scanning and may display a message 820 indicating that scanning has stopped.

According to an embodiment, when it is determined based on the motion information that the motion amount of the object is equal to or greater than the threshold level, the medical imaging apparatus 200 may automatically stop scanning and may re-scan the object. The medical imaging apparatus 200 may re-scan the object from the region of the object where scanning has stopped. Alternatively, the medical imaging apparatus 200 may re-scan the object from the beginning. For example, as shown in FIG. 8B, when a value of a motion index is equal to or greater than 3 and thus a scan is stopped at 60% process, the medical imaging apparatus 200 may re-scan the object from the region of the object where the scanning has stopped. For example, the medical imaging apparatus 200 may determine a region of a patient from which re-scanning is to start, based on the location of a table on which the patient lies.

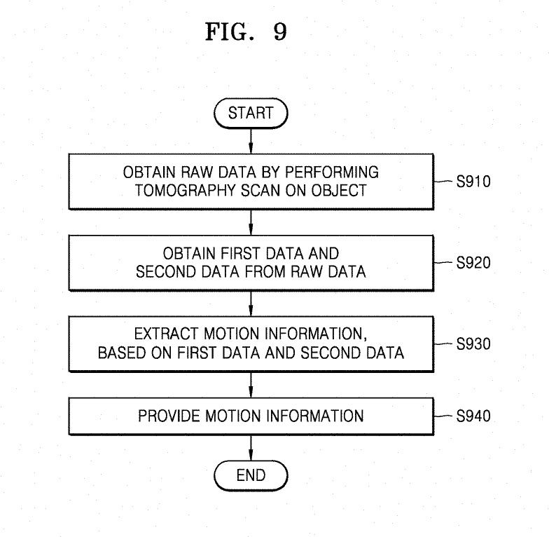

FIG. 9 illustrates a medical image processing method according to an embodiment.

The operations of a medical image processing method according to embodiments may be performed by an electronic device including a processor capable of performing image processing and a display. An embodiment in which the medical imaging apparatus 200 (hereinafter, 200 is used as a general reference numeral for a medical imaging apparatus disclosed in the present specification) performs a medical image processing method according to embodiments will be focused on. Thus, the embodiments described above regarding the medical imaging apparatus 200 are applicable to a medical image processing method, and, inversely, the embodiments described above regarding the medical image processing method are applicable to the embodiments for the medical imaging apparatus 200. The medical image processing method according to embodiments is performed by the medical imaging apparatus 200, but embodiments are not limited thereto. The medical image processing method according to embodiments may be performed by various types of electronic devices.

In operation S910, the medical imaging apparatus 200 obtains raw data by performing a tomography scan on an object.

In operation S920, the medical imaging apparatus 200 obtains first data and second data from the raw data. For example, the medical imaging apparatus 200 may obtain first data and second data respectively corresponding to different angular sections. For example, the different angular sections may be in the range of 0° or greater to less than 180° and may include opposite angular sections.

In operation S930, the medical imaging apparatus 200 extracts motion information, based on the first data and the second data.

According to an embodiment, the medical imaging apparatus 200 may calculate a motion vector by using the first image and the second image. For example, the medical imaging apparatus 200 may reconstruct a first image and a second image, based on the first data and the second data, and calculate a motion vector of each pixel by using the first image and the second image.

According to an embodiment, the medical imaging apparatus 200 may extract the motion information, based on the calculated motion vector. For example, the medical imaging apparatus 200 may calculate a value of a motion index, based on the motion vector. The medical imaging apparatus 200 may extract at least one pixel of which a motion vector is equal to or greater than a threshold, from a plurality of pixels corresponding to an FOI. The medical imaging apparatus 200 may calculate a value of a motion index by using the size of the motion vector of the extracted at least one pixel. For example, the medical imaging apparatus 200 may calculate a mean value of the size of the motion vector of the extracted at least one pixel and may map the calculated mean value to a predetermined value of a motion index, but embodiments are not limited thereto. According to an embodiment, values of motion indexes mapped according to sizes of motion vectors may vary depending on settings of a designer or a user's settings.

As another example, the medical imaging apparatus 200 may calculate a motion map, based on the motion vector. For example, the medical imaging apparatus 200 may generate the motion map by mapping a certain color to each pixel according to the size of the motion vector of each pixel.

In operation S940, the medical imaging apparatus 200 provides the motion information. For example, the medical imaging apparatus 200 may display the motion information as at least one of a motion index and a motion map. For example, the medical imaging apparatus 200 may display at least one of a motion index and a motion map together with the medical image obtained by scanning the object. According to an embodiment, the medical imaging apparatus 200 may overlap the medical image with the motion map, or compose the medical image and the motion map to display a single image, such that the motion information is displayed on the medical image.

The medical imaging apparatus 200 may output a message indicating that a motion amount of the object is equal to or greater than a threshold based on the motion information. For example, when a value of a motion index is equal to or greater than a threshold, the medical imaging apparatus 200 may output a message indicating that a re-scan is necessary. According to another embodiment, when the value of the motion index is equal to or greater than the threshold, the medical imaging apparatus 200 may display a certain sound or highlight the value of the motion index.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A medical imaging apparatus comprising:
a data obtainer configured to obtain raw data by performing a tomography scan on an object;
a processor configured to obtain first data and second data from raw data and extract motion information, based on the first data and the second data; and
an output interface configured to provide the extracted motion information.

2. The medical imaging apparatus of claim 1, wherein the output interface is configured to display the motion information as at least one of a value of a motion index and a motion map.

3. The medical imaging apparatus of claim 1, wherein the output interface is configured to display the motion information with a medical image generated by reconstructing the raw data.

4. The medical imaging apparatus of claim 1, wherein the output interface is configured to provide varying motion information in real time as the tomography scan proceeds on the object.

5. The medical imaging apparatus of claim 1, wherein the processor is configured to:
calculate a motion vector based on the first data and the second data; and
extract the motion information based on the motion vector.

6. The medical imaging apparatus of claim 5, wherein
the processor is configured to:
extract at least one pixel of which a size of a motion vector is equal to or greater than a threshold from a plurality of pixels corresponding to a field of interest (FOI); and
calculate a value of a motion index by using the size of the motion vector of the extracted at least one pixel; and
the output interface is configured to output the calculated value of the motion index as the motion information.

7. The medical imaging apparatus of claim 5, wherein the processor is configured to generate a motion map by mapping a certain color to each of pixels according to a size of the motion vector of each of the pixels.

8. The medical imaging apparatus of claim 7, wherein the output interface is configured to:
overlap a medical image generated by reconstructing the raw data with the motion map; and
display a result of the overlapping.

9. The medical imaging apparatus of claim 5, wherein the processor is configured to:
reconstruct a first image and a second image, based on the first data and the second data; and
calculate a motion vector of each pixel by using the first image and the second image.

10. The medical imaging apparatus of claim 1, wherein the output interface is configured to output a notification message when a value of a motion index provided as the motion information is equal to or greater than a threshold.

11. The medical imaging apparatus of claim 1, wherein the processor is configured to:
stop scanning when it is determined that a motion amount of the object is equal to or greater than a threshold, based on the motion information; and
re-scan the object from a location on the object where the scanning has stopped.

12. The medical imaging apparatus of claim 1, wherein the first data and the second data respectively correspond to different angular sections.

13. The medical imaging apparatus of claim 12, wherein the different angular sections are opposite angular sections and in a range of 0° or greater to less than 180°.

14. A medical image processing method comprising:
obtaining raw data by performing a tomography scan on an object;
obtaining first data and second data from the raw data;
extracting motion information, based on the first data and the second data; and
providing the motion information.

15. The medical image processing method of claim 14, wherein the providing the motion information comprises displaying the motion information as at least one of a value of a motion index or a motion map.

16. The medical image processing method of claim 14, wherein the providing the motion information comprises displaying the motion information together with a medical image generated by reconstructing the raw data.

17. The medical image processing method of claim 14, wherein the extracting the motion information comprises:
calculating a motion vector, based on the first data and the second data; and
extracting the motion information based on the motion vector;

18. The medical image processing method of claim 17, wherein
the extracting of the motion information comprises:
extracting at least one pixel of which a size of a motion vector is equal to or greater than a threshold from a plurality of pixels corresponding to a field of interest (FOI); and
calculating a value of a motion index by using the size of the motion vector of the extracted at least one pixel, and
the providing of the motion information comprises outputting the calculated value of the motion index as the motion information.

19. The medical image processing method of claim 14, wherein the providing of the motion information comprises outputting a notification message when a value of a motion index provided as the motion information is equal to or greater than a threshold.

20. A non-transitory computer-readable recording medium having recorded thereon a computer program code which, when executed by a processor, performs a medical image processing method comprising:
obtaining raw data by performing a tomography scan on an object;
obtaining first data and second data from the raw data;
extracting motion information, based on the first data and the second data; and
providing the extracted motion information.
